(19) United States
(12) Patent Application Publication
(10) Pub. No.: US 2001/0041545 A1
(43) Pub. Date: Nov. 15, 2001

(54) Radiation shield for radio transmitting devices

(76) Inventors: Marty Liberman, Montreal (CA); Marilyn MacGillivray, Lachine (CA)

Correspondence Address: Bhupinder Randhawa, Bereskin & Parr, Box 401, 40 King Street West, Toronto, ON, M5H 3Y2, CA

(21) Appl. No.: 09/767,833

(22) Filed: Jan. 24, 2001

Related U.S. Application Data
(60) Provisional application No. 60/177,635, filed on Jan. 24, 2000.

(51) Int. Cl. H04B 1/04

(52) U.S. Cl. 455/117; 455/90; 455/575

(57) ABSTRACT

A radiation blocking device for use with a portable communication apparatus such as a cordless or cellular phone. The device has a radiation shield and a connector for attaching the shield to the apparatus. The shield is sized and shaped to reflect radiation emitted by the antenna which would otherwise strike the head of a user of the apparatus. The shield also reflects and absorbs heat emitted by the antenna, reducing the amount of such heat incident on said user's head. The shield is in the shape of an arc of circle and is preferably positioned concentrically with the antenna.

### FIELD OF THE INVENTION

The present invention relates to portable phones and radios, and more particularly, the invention relates to radiation shields for blocking electro-magnetic radiation and heat emitted by the antennas of such phones and radios.

### BACKGROUND OF THE INVENTION

Portable communication devices such as portable phones, including both cellular phones and cordless phones for the home, have increased in popularity significantly in recent years. Each of these devices communicates with a base station using electro-magnetic signals. In the case of a cordless phone, the base station is usually located within 100 metres of the portable unit. In the case of a cellular phone, the base station may be a communication tower located many kilometres from the portable unit.

Portable phones operate on a wide range of signal frequencies. For example, older analog cell phones typically operate at frequencies of approximately 850-900 MHz, while newer digital cell phones operate on the order of 1800 MHz, or 1.8 GHz. Cordless phones for use in the home operate at about 45 MHz, 900 MHz, and more recently, 2.4 GHz, depending on the type. Portable phones, cordless phones and other types of wireless communication devices also operate at other frequencies. In this application, we will refer to portable phones. The invention is equally applicable to other portable communication devices.

An increasingly urgent concern among consumers in recent years, is that portable phones may present a health risk to a user when the phone is held close to the head when in use. This concern has sparked many studies of the health risks to portable phone users, based on the signal frequencies of the phone, and the usage characteristics, such as the distance of the portable phone from the head of the user and overall hours of usage. These health risks are believed to be greater when a higher frequency portable phone is used, as is increasingly the case.

Such studies have shown that heath risks associated with radiation from portable phones may include headaches, loss of concentration, loss of memory and brain tumors. Almost all portable phones have an antenna for transmitting and receiving the electromagnetic signals which allow communication with the base station. The antenna generally extends vertically from the housing of the portable phone. Given its role in a portable phone's communication system, the antenna is one of the largest sources of radiation emitted by a portable phone.

Some research has also shown that portable phone antennas also emit heat, which can cause a user's head to be warmed, especially when a portable phone is used for an extended period. This may also be associated with adverse health effects.

It is therefore desirable to reduce the exposure of a portable phone user to the electro-magnetic radiation and heat emitted from a portable phone antenna. Several existing devices have been used for this purpose.

U.S. Pat. No. 5,819,162 (Spann et al.) discloses a flip-up shield that mounts around the earpiece region of a portable phone. In use, the shield flips up and is positioned between the antenna and the user's head. The device is particularly intended to block radiation emitted by the antenna from striking a hearing aid worn by the user, and thereby reduces the adverse effects of the radiation on the operation of the hearing aid. This device has several disadvantages. The device is bulky and has a relatively unsightly appearance. It also requires that the user actively flip the shield into its operational position prior to each use of the portable phone. A user may forget to do so, particularly when receiving a phone call. Furthermore, the shape and size of the device are not configured to protect the user's entire head from radiation.

U.S. Pat. No. 5,338,896 (Danforth) discloses a sliding planar shield for a portable phone with an antenna. The shield includes a rectangular body, an upper tab for attachment to the antenna, and two lower tabs for attachment of the shield to the phone. This device alters the appearance of the portable phone undesirably, and adds significant bulkiness to the phone, due to the shape of the shield. Furthermore, this device is useful only with portable phone antennas which may be extended. Increasingly, portable phone antennas are either non-extending (particularly in higher frequency digital phones) or may be extended optionally (in “dual mode” cellular phones, which are capable of operating at more than one frequency).

U.S. Pat. No. 5,335,366 (Daniels) discloses a sleeve that completely surrounds the antenna of a portable phone, and contains a barrier layer which shields the user from radiation emitted by the antenna. The sleeve, however, reduces the communication performance of the antenna, because both incoming and outgoing signals are disrupted by the shield as well.

Accordingly, there exists a need for a device that effectively shields a portable phone user from radiation emitted from the phone's antenna. Preferably, the device does not substantially interfere with the communication function of the antenna. Preferably, the device does not require the user to actively place it into the desired position each time the portable phone is to be used.

### SUMMARY OF THE INVENTION

The present invention provides a radiation blocking device which has a radiation shield and a connector. The radiation shield and connector are rigidly attached by a neck. Preferably, the entire device is formed from an integral piece of metal. The connector is formed as a cylinder with a slit or gap on one side. The connector is friction fitted onto the antenna or the base of the antenna of a portable phone. The shield is then held in a fixed position between the antenna and a user's head by the connector and the neck. The shield is shaped to block any line of sight between the antenna and the user's head, so that any electro-magnetic signal emitted by the antenna is reflected away from the user's head. The shield thus provides a three dimensional region of space in which the electro-magnetic radiation emitted by the antenna is substantially attenuated and within which the user's head will be positioned when the portable phone is in use.

The shield is preferably made of metal and the preferred embodiment is formed from a single piece of a brass alloy with a nickel plating. The shield also provides a heat blocking function to reduce the effects of heat emitted from the portable phone antenna on the user. Some of the emitted heat is reflected by the shield while additional heat is absorbed and later dissipated into the ambient environment.

The radiation shield is shaped as a part of a cylinder and its cross-section, in a direction perpendicular to the axis of the antenna of the portable phone, appears as an arc of a circle. Preferably, the axis of this circle is co-axial with the axis of the antenna when the device is mounted on the portable phone.

Th neck of the device is angled so that the radiation shield is spaced apart from the antenna in use. A pair of tabs extend from the shield adjacent the neck to prevent radiation from passing through the gap created by the neck and striking the user's head.

The radiation shield is configured to mounted on the portable phone and left in place. It thus provides automatic protection from both electro-magnetic radiation and heat emitted from the antenna without the user taking any additional steps each time he or she uses the phone.

In one aspect, the present invention provides a device for blocking electro-magnetic radiation emitted by an antenna of a portable communication apparatus, the device comprising: a radiation shield having a perimeter; and a connector to mount the radiation shield on the apparatus such that, when the device is mounted to the apparatus, the radiation shield together with the antenna defines a three dimensional region in which electro-magnetic radiation emitted by the antenna is attenuated, and whereby, when said apparatus is used by a user, the region is sufficiently large to encompass a head of the user.

In a second aspect, the present invention provides a radiation blocking device for use with a portable communication apparatus having an antenna, the portable communication apparatus configured to be positioned adjacent a user's head, the radiation block device comprising: a radiation shield for blocking electro-magnetic radiation emitted by the antenna; and a connector rigidly coupled to the radiation shield, the connector adapted for mounting to the portable communication apparatus such that the radiation shield is positioned between the antenna and the user's head.

In a third aspect the present invention provides a device for blocking electro-magnetic radiation emitted by an antenna of a portable communication apparatus, the device comprising: means for blocking radiation, said radiation blocking means having a perimeter; and means for connecting to mount the radiation blocking means on the apparatus such that, when the device is mounted to the apparatus, the radiation blocking means together with the antenna defines a three dimensional region in which electromagnetic radiation emitted by the antenna is attenuated, and whereby, when said apparatus is used by a user, the region is sufficiently large to encompass a head of the user.

In a fourth aspect the present invention provides a device for use with a portable communication apparatus having an antenna, the portable communication apparatus configured to be positioned adjacent a user's head, the device comprising: means for blocking radiation, said radiation blocking means adapted to block electro-magnetic radiation emitted by the antenna; and means for connecting rigidly coupled to the radiation blocking means, the connecting means adapted for mounting the device to the apparatus such that the radiation blocking means is positioned between the antenna and the user3 s head.

Additional aspects and characteristics of the present invention are set out below in the description of the preferred embodiments.

### DESCRIPTION OF THE DRAWINGS

The present invention will now be described by way of example only, with reference to the drawings in which:

FIG. 1 is an isometric view of a portable phone and a radiation blocking device in accordance with a first preferred embodiment of the present invention;

FIG. 2 is a cross-sectional view of a shield of the device of claim 1;

FIG. 3 is a cross-sectional view of a connector of the device of claim 1;

FIG. 4 is a side view of the device of FIG. 1, mounted on a portable phone in use by a user;

FIG. 5 is a magnified view of a portion of FIG. 2; and

FIG. 6 is a plan view of the device of FIG. 1 mounted on a portable phone in use by a user; and

FIG. 7 is a plan view of the shield of the device of claim 1 and several base stations.

### DESCRIPTION OF THE PREFERRED EMBODIMENTS

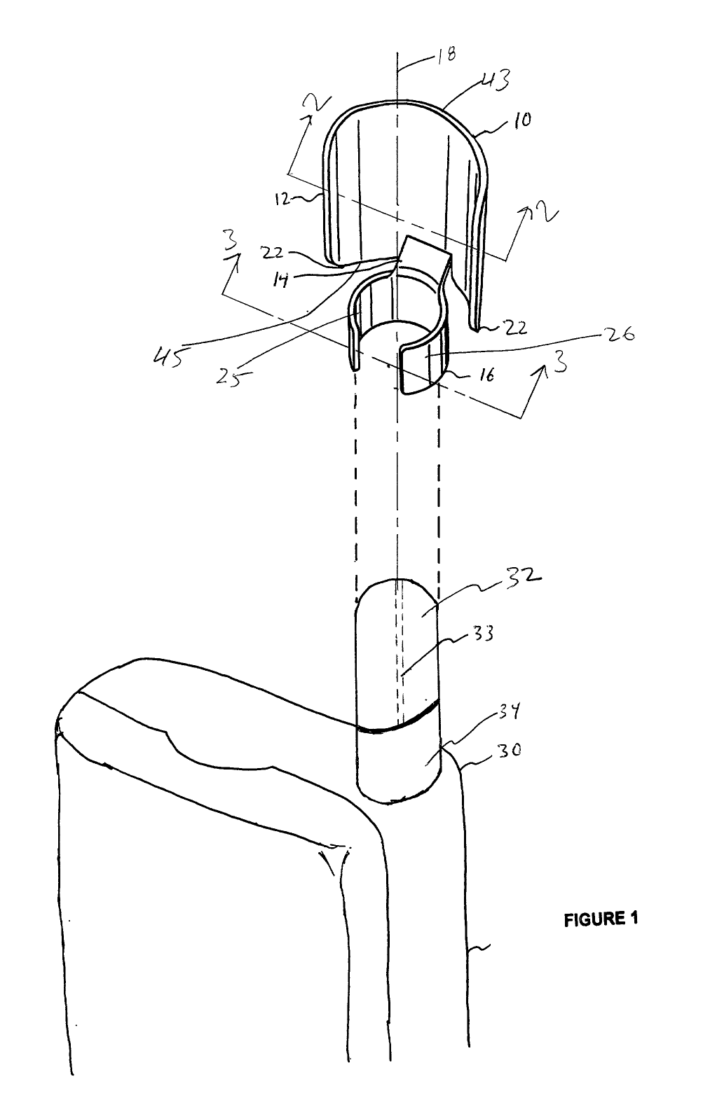

Reference is first made to FIG. 1, which illustrates a radiation blocking device 10 made in accordance with a first embodiment of the present invention. Device 10 has a radiation shield 12, a neck 14 and a connector 16. Neck 14 joins shield 12 and connector 16 such that they are held in a fixed position relative to one another. Shield 12 is at the top of device 10 and connector 16 is at the bottom of device 10.

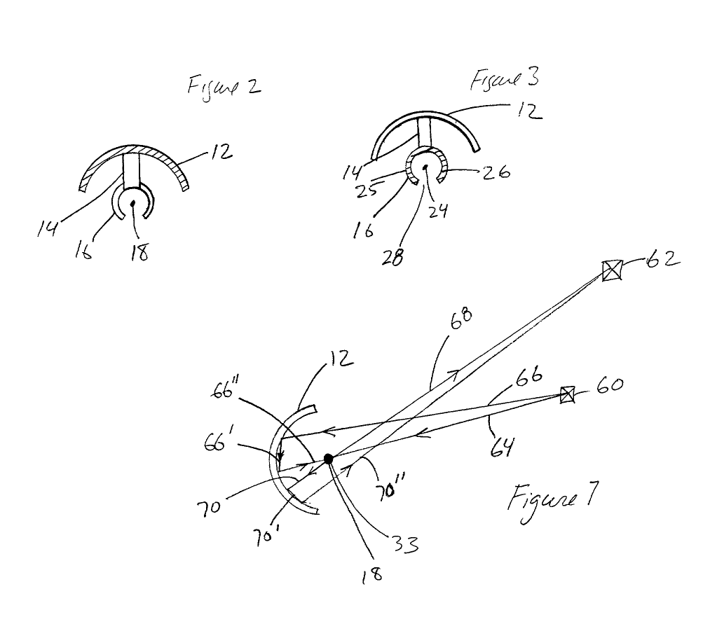

FIG. 2 is a cross-sectional view of shield 12. Shield 12 is formed as an arc of a circle, with an axis 18. Shield 12 has a radius R_{c} and an included arc angle A_{c}. FIG. 3 is a cross-sectional view of connector 16, which is also formed as an arc of a circle, with an axis 24. Connector 16 has a radius Rₛ. Connector 16 has a pair of arms 25 and 26 which are separated by a gap 28. The radius R_{c} of shield 12 is greater than the radius R_{c} of connector 16.

Referring again to FIG. 1, shield 12 has a pair of extension tabs 22 which extend downward adjacent the top of neck 12.

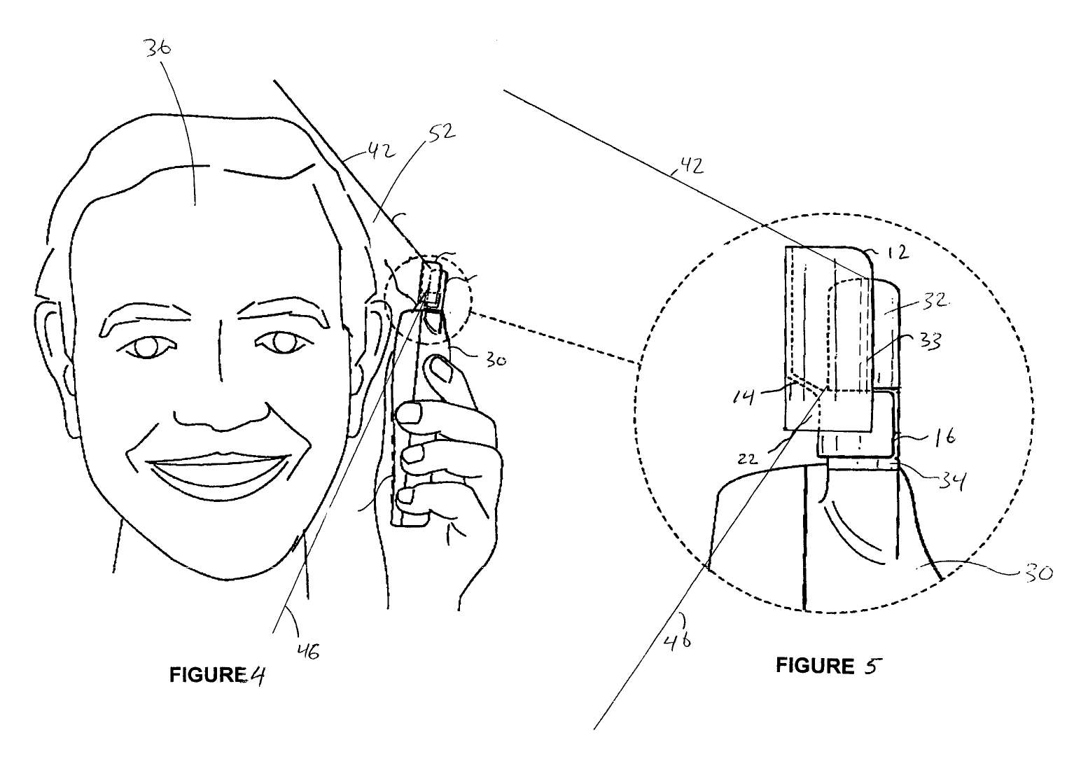

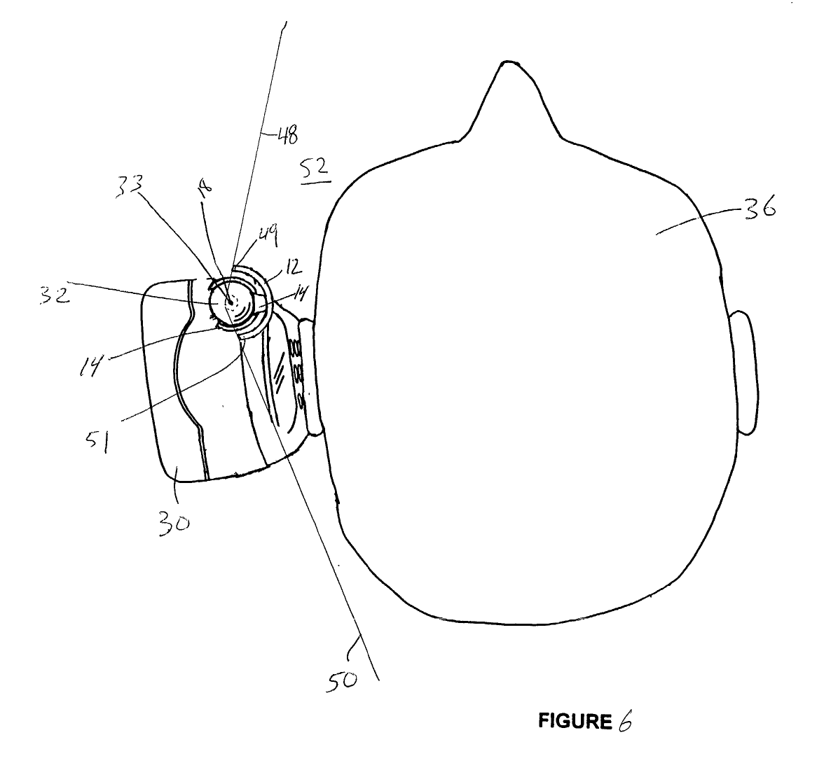

In use, device 10 is mounted onto a portable phone 30 (or other portable communication device), as shown in FIGS. 4, 5 and 6. Phone 30 has an antenna housing 32, which extends from the top of the phone's housing 34. Typically, antenna housing 32 will have a base 34, although this is not always the case, and is not necessary. In this example, antenna housing 32 is not extendable from its base 34, as is typical for modern higher frequency digital cellular phones (often referred to as “PCS” phones). Antenna housing 32 contains an antenna 33, which is coupled to the communications circuitry (not shown) of the phone 30. Typically, housing 32 will be generally cylindrical with a diameter between 5-15 mm. Antenna 33 will typically be an elongated wire or metal cylinder and will be installed along the axis of antenna housing 32.

To install device 10 onto phone 30, connector 16 is slid onto and frictionally engages base 34 (or antenna housing 32). Connector 16 holds device 10 on phone 30 such that shield 12 is positioned between the head 36 of a user and antenna 33. Prior to installing connector 16 onto base 34, the user 36 may open or close arms 25 and 26 to provide a larger or smaller radius R_{c}, so that connector 16 will be able to engage base 34 with sufficient force to hold device 10 in place. Preferably, when connector 16 is installed on base 34, the axis 18 of shield 12 is positioned co-axially with antenna 33.

When phone 30 is in use, antenna 33 will emit electro-magnetic radiation and heat. The emitted electro-magnetic radiation will propogate in all directions from antenna 33 in straight lines, including the direction of the user's head 36.

Shield 12 is positioned such that it blocks any line of sight between antenna 32 and the user's head 36 (i.e. no radiation vector emitted by antenna 33 can strike the user's head, since it will be reflected shield 12). When connector 16 is positioned on base 34, the top 40 of shield 12 extends higher than the top edge 43 of antenna 12 such that a surface 42, which is defined by the top of antenna 32 and the top edge 43 of shield 12 passes above the user's head 36. Similarly, the bottom edge 47 of shield 12 extends below the bottom of antenna 32 so that a surface 46, which is defined by the bottom edge 47 of antenna 33 and the bottom side of shield 12 passes below the user's head 36. Surfaces 42 and 46 are shown in cross-section in FIGS. 4 and 5 as lines. Surfaces 42 and 46 may be complex 3-dimensional surfaces, depending on the exact shape of the top edge 43 and bottom edge 47 of shield 12. Surfaces 42 and 46 define the limits of protection provided by shield 12 in an upward and downward direction to block radiation emitted by antenna 33 from striking the user's head 36. One skilled in the art will recognize that neck 14 will block some radiation emitted by antenna 33. One skilled in the art will recognize that this will not detrimentally affect the position of surface 46, since the presence of neck 14 will simply block radiation emitted by antenna 33 from striking parts of the user's body in addition to the user's head 36.

Reference is next made to FIG. 6, which is a plan view of device 10, phone 30 and the user's head 36 when the phone 30 is in use and the device 10 has been installed as described above. Surface 48, which is defined by the axis 18 of shield 12 (which is preferably co-axial with antenna 33) and the front edge 49 of shield 12 (when viewed from the perspective of the user) passes in front of the user's head 36. Surface 50, which is defined by the axis 18 of shield 12 and the rear edge 51 of shield 12 passes behind the user's head 36. Surfaces 48 and 50 are shown in FIG. 6 in cross-section as lines. Surfaces 48 and 50 define the frontward and rearward limits of protection provided by shield 12 to block radiation emitted by antenna 33 from striking the user's head 36.

Shield 12 operates by reflecting electromagnetic radiation which strikes it. Thus, electro-magnetic radiation emitted by antenna 33 that strikes shield 12 is prevented from striking an object on the opposite side of shield 12. Collectively, surfaces 42, 46, 48 and 50 define a three dimensional region of space 52 which extends from the location of antenna 33 outward. Region 52 defines the range of protection of shield 12 and when phone 30 is in use and device 10 is properly installed, the user's head 36 will be positioned within region 52.

Radiation shield 12 is preferably, although not necessarily, spaced transversely (compared to its axis) away from antenna housing 32 by neck 14. The presence of neck 14 can create a gap between radiation shield 12 and connector 16. Tabs 22 extend downward from shield 12 to ensure that no radiation emitted by antenna 33 passes through the gap and strikes the user's head 36.

The shape and size of region 52 depends on (i) the shape and size of antenna 33, (ii) the height of shield 12 between its top edge 43 and its bottom edge 47, (iii) the included angle Aₛ of shield 12 between its front edge 49 and its rear edge 51 and (iv) the placement of shield 12 relative to antenna 33. A person skilled in the art will be capable of selecting the height, included angle and placement of shield 12 to ensure that the user's head 36 is within region 52 when a selected phone 30 is in use. These criteria are selected so that there is no line of sight between the antenna 33 and the user's head 36. The placement of shield 12 will depend on the length and angle of neck 14, and selection of these characteristics is also within the competence of one skilled in the art.

The preferred embodiment of shield 12 is formed of a brass alloy which provides a substantial attenuation of the electromagnetic radiation emitted by antenna 33. The radiation blocking characteristics of brass and brass alloys are well understood and a person skilled in the art will be capable of selecting a suitable material. A brass alloy which provides some resilience and rigidity is preferable for the present purpose. Such an alloy will provide a less deformable device 10 and shield 12 than pure brass.

Preferably, device 10 is formed from a single piece of metal. If device 10 is made from two or more parts (i.e. where shield 12, neck 14 and connector 16 are first separately in two or three parts and then joined by welding or another method of fastening), the resulting device may be prone to weak spots at its joints, where it may break. Although such a device is not preferred by the inventor, it will still fall within the scope of the present invention.

In the preferred embodiment of device 10, it is coated with a nickel plating. This coating provides some additional reflection of electro-magnetic radiation and heat, although its function is primarily aesthetic. Device 10 may alternatively be coated with a plastic material or paing which can be colored to match the color of phone 20. Alternatively, device 10 may not be coated or may have another coating.

In addition to protection from electromagnetic radiation, shield 12 also provides the user with protection from heat emitted from antenna 33. Heat emitted by antenna 33 is both reflected and absorbed by shield 12. The reflected heat is reflected in a direction opposite that the of the user's head 36, and therefore does not affect the user. Heat that is absorbed is later dissipated into the ambient environment. Although some of this dissipated heat may reach the user's head 36, it is likely that much of the absorbed heat will be dissipated when the phone 30 and device 10 are not in use, after a phone call. In addition, device 10 may act as heat sink and may absorb some heat directly from antenna 33 or its base 34 through connector 16. This heat will also be dissipated subsequently to the ambient environment. By these operations, a substantial amount of the heat generated by antenna 33 during a phone call will be prevented from striking the user's head 36.

Since connector 16 and neck 14 are also preferably made from the same material as radiation shield 12, connector 16 and neck 14 may also provide radiation blocking, heat blocking and heat absorbing effects, enhancing the efficacy of device 10 is protecting the user.

Reference is next made to FIG. 7. The inventor has found that the use of device 10 can increase the effectiveness of antenna 33 in transmitting and receiving electro-magnetic signals when communicating with a base station. FIG. 7 illustrates shield 12, antenna 33 and two base stations 60, 62 in plan view.

Typically, phone 30 (not shown in FIG. 7) will be in communication with one base station at a time. Line 64 and 66 illustrate two “rays” of the electromagnetic signal which will be transmitted by base station 60 when phone 30 is communication with it. Typically, rays 64 and 66 will contain identical information. Ray 64 is received directly by antenna 33, as is well understood in the art. Ray 66, however, initially passes and is not received by antenna 33. The inventor believes that shield 12 operates to reflect ray 66 (or the energy in ray 66) so this is reflected into antenna 33 as shown at 66′ and 66″. In this way, shield 12 operates to focus some of the electro-magnetic signal that is transmitted by base station 60 and is incident on shield 12 on to antenna 33 and thereby increase the strength of the signal received by antenna 33.

At another time, phone 30 may be in communication with base station 62. Lines 68 and 70 represent two rays of the electromagnetic signal transmitted by antenna 33. Ray 68 is transmitted directly to and received by base station 62. Ray 70 is reflected by shield 12 and re-directed as rays 70′ and 70″. Ray 70″ is received base station 62. In this way, some of the electro-magnetic signal which is transmitted by antenna 33 and which is incident on shield 12 is directed to base station 62, increasing the strength of the signal received by base station 62 from phone 30.

The present invention provides several advantages over prior art devices. The present invention allows a portable phone user to protect his or her head from the effects of electro-magnetic radiation and heat emitted by a portable phone's antenna. The present device does need to be removed between uses of the portable phone, and once affixed does not require any steps to put it into operation prior to uses of the portable phone. The present device thus provides effective and automatic protection to the user.

A preferred exemplary embodiment has been described. Other embodiments of the present invention may have additional features.

Depending on the degree and type of protection required from device 10, shield 12 may not be configured to shield the entire head 36 of a user, or it may be configured to protect additional parts of the user's body (for example, the user's neck). In this case, the height and included angle of the shield will be varied so that the region 52 includes those parts of the user's body that are desired to be protected.

The connector 16 of the device 10 described above had a circular cross section, with a gap 28. Many portable phones have an antenna base or an antenna housing which is not circular. For use with these phones, the connector 16 of device 10 may be shaped to frictionally engage such an antenna base or antenna housing. Furthermore, many portable phones may also provide another means for attaching device 10. In this case, connector 16 may be shaped to engage such means, which may include recesses in the housing of the portable phone, or frictional engagement with a portion of the housing of the portable phone or another means.

The preferred embodiment described above was described in the context of an antenna 33 which has a base 34 and which does not extend from phone housing. Some portable phones do not have a base 34 for their antennas. In this case, the connector 16 may be attached directly to the antenna of the phone, and if necessary, neck 16 may be formed such that the bottom edge of shield 12 extends below the bottom edge of the connector 16.

Many portable phones have an extendible antenna. Shield 12 may be elongated between its top and bottom edges to provide protection to a user's head from the entire length of such an extendible antenna.

In another embodiment of the present invention, the inner surface of the connector 16 may be coated with an adhesive or high friction material or may be formed to provide greater frictional engagement with base 34. For example, the inner surface of connector 16 may be grooved or notched. This will produce a stronger mounting of device 10 on base 34.

The shield 12 of device 10 has been illustrated in the Figures with rounded corners. In another embodiment, the shield 12 may have square corners.

A preferred embodiment of the present invention and several variations of it have been described. Other variations of the invention are possible, and each of these fall within the spirit and scope of the invention, which is limited only by the appended claims.

We claim:

1. A device for blocking electro-magnetic radiation emitted by an antenna of a portable communication apparatus, the device comprising:
(a) a radiation shield having a perimeter; and
(b) a connector to mount the radiation shield on the apparatus such that, when the device is mounted to the apparatus, the radiation shield together with the antenna defines a three dimensional region in which electro-magnetic radiation emitted by the antenna is attenuated,
and whereby, when said apparatus is used by a user, the region is sufficiently large to encompass a head of the user.

2. The device of claim 1 further comprising a neck rigidly mounted between the radiation shield and the connector for holding the radiation shield and the connector in a fixed position relative to one another.

3. The device of claim 1 wherein the antenna has a first axis and wherein a cross section of the radiation shield in a plane transverse to said first axis is an arc of a circle, the circle having a second axis, and wherein the first axis and the second axis are co-axial when the device is mounted on the apparatus.

4. The device of claim 2 wherein the radiation shield is positioned concentrically with the antenna when the device is mounted on the apparatus.

5. The device of claim 4 wherein, when the device is mounted on the apparatus, the radiation shield is spaced apart from the antenna in a direction transverse to an axis of said antenna.

6. The device of claim 1 wherein the connector is adapted to frictionally engage a portion of the apparatus.

7. The device of claim 1 wherein the connector is adapted to frictionally engage an antenna base of the apparatus.

8. The device of claim 1 wherein the connector is adapted to frictionally engage the antenna.

9. The device of claim 1 wherein the device is formed from an integral piece of metal.

10. The device of claim 1 wherein the device is formed from brass.

11. The device of claim 1 wherein the device is formed from a brass alloy.

12. The device of claim 1 wherein the device has a coating selected from the group comprising:
(i) nickel;
(ii) paint;
(iii) plastic;
(iv) tin;
(v) tin-lead; and
(vi) chrome.

13. The device of claim 2 further comprising tabs extending from the radiation shield adjacent the neck.

14. A device for use with a portable communication apparatus having an antenna, the portable communication apparatus configured to be positioned adjacent a user's head, the device comprising:
(a) a radiation shield for blocking electro-magnetic radiation emitted by the antenna; and
(b) a connector rigidly coupled to the radiation shield, the connector adapted for mounting the device to the apparatus such that the radiation shield is positioned between the antenna and the user's head.

15. The device of claim 14 further comprising a neck mounted between the radiation shield and the connector for rigidly holding the radiation shield and the connector in a fixed position relative to one another.

16. The device of claim 14 wherein the antenna has a first axis and wherein the radiation shield has a second axis, and wherein the first axis and the second axis are co-axial when the device is mounted on the apparatus.

17. The device of claim 16 wherein the radiation shield has a cross-section shaped as an arc of a circle and wherein the second axis is the axis of the circle.

18. The device of claim 14 wherein the antenna has a first axis and the radiation shield has a cross-section shaped as an arc of a circle, in a plane transverse to said first axis.

17. The device of claim 14 wherein the radiation shield is positioned concentrically with the antenna when the device is mounted on the apparatus.

18. The device of claim 17 wherein, when the device is mounted on the apparatus, the radiation shield is spaced apart from the antenna in the transverse direction.

19. The device of claim 14 wherein the connector is adapted to frictionally engage a portion of the apparatus.

20. The device of claim 14 wherein the connector is adapted to frictionally engage an antenna base of the apparatus.

21. The device of claim 14 wherein the connector is adapted to frictionally engage the antenna.

22. The device of claim 14 wherein the device is formed from an integral piece of metal.

23. The device of claim 14 where the device is formed from brass.

23. The device of claim 14 wherein the device is formed from a brass alloy.

24. The device of claim 14 wherein the device has a coating selected from the group comprising:
(i) nickel;
(ii) paint;
(iii) plastic;
(iv) tin;
(v) tin-lead; and
(vi) chrome.

25. The device of claim 14 further comprising tabs extending from the radiation shield adjacent the neck.

26. The device of claim 14 wherein the radiation shield, when the device is mounted on the apparatus, the radiation shield together with the antenna defines a three dimensional region in which electro-magnetic radiation emitted from the antenna is attenuated.

27. The device of claim 26 wherein the radiation shield has a perimetric extent which corresponds to the limits of the region.

28. The device of claim 26 wherein the user's head is positioned within the region when the apparatus is in use.

29. The device of claim 14 wherein the radiation shield has a perimeter defined by a top edge, a bottom edge, a front edge and a rear edge, and wherein, when the shield is mounted on the apparatus, radiation emitted by the antenna is attenuated in a three dimensional region defined by the:
(a) the top edge of the radiation shield and the top of the antenna;
(b) the bottom edge of the radiation shield and the bottom of the antenna;
(c) the front edge of the radiation shield and the axis of the antenna; and
(d) the rear edge of the radiation shield and the axis of the antenna,
wherein the region extends from the radiation shield in a direction opposed to the antenna.

30. The device of claim 29 wherein the user's head is positioned within the region when the apparatus is in use.

31. A device for blocking electro-magnetic radiation emitted by an antenna of a portable communication apparatus, the device comprising:
(a) means for blocking radiation, said radiation blocking means having a perimeter; and
(b) means for connecting to mount the radiation blocking means on the apparatus such that, when the device is mounted to the apparatus, the radiation blocking means together with the antenna defines a three dimensional region in which electromagnetic radiation emitted by the antenna is attenuated,
and whereby, when said apparatus is used by a user, the region is sufficiently large to encompass a head of the user.

32. The device of claim 31 further comprising a means for joining mounted between the radiation blocking means and the connecting means for holding the radiation blocking means and the connecting means in a fixed position relative to one another.

33. The device of claim 31 wherein the antenna has a first axis and wherein a cross section of the radiation blocking means in a plane transverse to said first axis is an arc of a circle, the circle having a second axis, and wherein the first axis and the second axis are co-axial when the device is mounted on the apparatus.

34. The device of claim 32 wherein the radiation blocking means is positioned concentrically with the antenna when the device is mounted on the apparatus.

35. The device of claim 34 wherein, when the device is mounted on the apparatus, the radiation blocking means is spaced apart from the antenna in the transverse direction.

36. The device of claim 32 further comprising extension means extending from the radiation blocking means adjacent the joining means.

37. A device for use with a portable communication apparatus having an antenna, the portable communication apparatus configured to be positioned adjacent a user's head, the device comprising:
(a) means for blocking radiation, said radiation blocking means adapted to block electro-magnetic radiation emitted by the antenna; and
(b) means for connecting rigidly coupled to the radiation blocking means, the connecting means adapted for mounting the device to the apparatus such that the radiation blocking means is positioned between the antenna and the user's head.

38. The device of claim 37 further comprising a joining means mounted between the radiation blocking means and the connecting means for rigidly holding the radiation blocking means and the connecting means in a fixed position relative to one another.

39. The device of claim 37 wherein the antenna has a first axis and wherein the radiation blocking means has a second axis, and wherein the first axis and the second axis are co-axial when the device is mounted on the apparatus.

40. The device of claim 39 wherein the radiation blocking means has a cross-section shaped as an arc of a circle and wherein the second axis is the axis of the circle.

41. The device of claim 37 wherein said antenna has a first axis and wherein the radiation blocking means has a cross-section shaped as an arc of a circle in a plane transverse to said first axis.

42. The device of claim 37 wherein the radiation blocking means is positioned concentrically with the antenna when the device is mounted on the apparatus.

43. The device of claim 40 wherein, when the device is mounted on the apparatus, the radiation blocking means is spaced apart from the antenna in the transverse direction.

44. The device of claim 37 further comprising tabs extending from the radiation blocking means adjacent the joining means.

45. The device of claim 37 wherein the radiation blocking means, when the device is mounted on the apparatus, the radiation blocking means together with the antenna defines a three dimensional region in which electro-magnetic radiation emitted from the antenna is attenuated.

46. The device of claim 45 wherein the radiation blocking means has a perimetric extent which corresponds to the limits of the region.

47. The device of claim 45 wherein the user's head is positioned within the region when the apparatus is in use.

48. The device of claim 37 wherein the radiation blocking means has a perimeter defined by a top edge, a bottom edge, a front edge and a rear edge, and wherein, when the shield is mounted on the apparatus, radiation emitted by the antenna is attenuated in a three dimensional region defined by the:
(a) the top edge of the radiation blocking means and the top of the antenna;
(b) the bottom edge of the radiation blocking means and the bottom of the antenna;
(c) the front edge of the radiation blocking means and the axis of the antenna; and
(d) the rear edge of the radiation blocking means and the axis of the antenna,
wherein the region extends from the radiation blocking means in a direction opposed to the antenna.

49. The device of claim 48 wherein the user's head is positioned within the region when the apparatus is in use.
